(19) United States
(12) Patent Application Publication
(10) Pub. No.: US 2012/0105482 A1
(43) Pub. Date: May 3, 2012

(54) PORTABLE ELECTRONIC DEVICE

(75) Inventor: DAN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/963,821

(22) Filed: Dec. 9, 2010

(30) Foreign Application Priority Data
Oct. 27, 2010 (CN) 201010521496.9

(51) Int. Cl. G09G 5/00

(52) U.S. Cl. 345/658; 345/649

(57) ABSTRACT

A portable electronic device includes a first display, a second display, a pivot, and an angle detector. The first display has a first display screen. The second display has a second display screen. The pivot connects the first display and the second display. An angle defined by the first display screen and the second display screen can be changed. The angle detector detects the different angles defined by the first display screen and the second display screen. The portable electronic device has at least two working modes respectively corresponding to the different angles. The portable electronic device automatically switches to a corresponding working mode according the angle detected by the angle detector.

### BACKGROUND

1. Technical Field

The present disclosure generally relates to electronic devices, and more particularly to a portable electronic device.

2. Discussion of Related Art

Portable electronic devices, such as personal computers, usually include a display screen and a keypad pivotably attached to the display screen. The display screen and the keypad have an angle arranged between 0 and 180 degrees. Since special functions of the display screen and the keypad are unchangeable, the portable electronic device has only one mode and lacks value-added features to satisfy consumer's requirements.

Therefore, what is needed is a portable electronic device, which can overcome the above described shortcomings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a perspective view of a portable electronic device in accordance with an embodiment of the present disclosure in a first operational state.

FIG. 2 is a perspective view of the portable electronic device of FIG. 1 in a second operational state.

FIG. 3 is a perspective view of the portable electronic device of FIG. 1 in a third operational state.

### DETAILED DESCRIPTION OF EMBODIMENTS

Reference will now be made to the drawings to describe various embodiments of the present portable electronic device in detail.

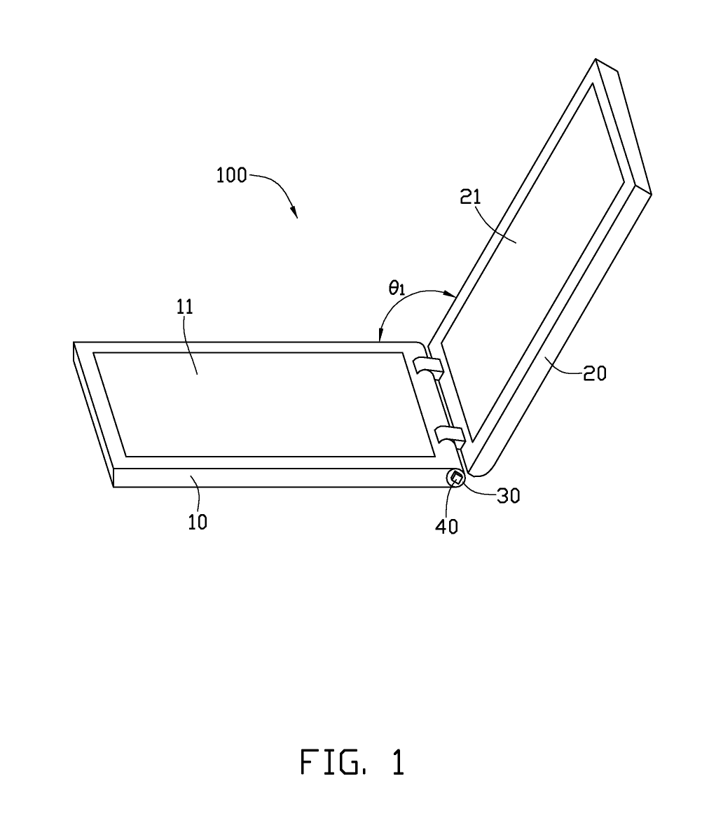

Referring to FIG. 1, a portable electronic device 100, in accordance with the present embodiment, includes a first display 10, a second display 20, a pivot 30, and an angle detector 40.

The first display 10 has a first display screen 11. The second display 20 has a second display screen 21. In the present embodiment, the first display screen 11 and the second display screen 21 are display screens integrated with touch keypad, and can be selected from an existing touch panel integrated with a liquid crystal display (LCD) or a cathode ray tube (CRT). The first display screen 11 and the second display screen 21 are configured for inputting and outputting information. In the present embodiment, the first display screen 11 and the second display screen 21 are 4-wire resistive touch panels. When a user presses the 4-wire resistive touch panel, the 4-wire resistive touch panel checks the position according the changed resistance, therefore, the corresponding information and operating instructions can be input thereby.

The pivot 30 pivotably connects the first display 10 and the second display 20; therefore, the first display 10 and the second display 20 can be rotated relative to each other freely. In the present embodiment, the first display screen 11 of the first display 10 is opposite to the second display screen 21 of the second display 20. In other words, when an angle defined by the first display 10 and the second display 20 is 180 degrees, the first display 10 and the second display 20 are positioned in the same horizontal plane.

In the present embodiment, the angle detector 40 is arranged at one side of the pivot 30, and configured for detecting the angle defined by the first display screen 11 and the second display screen 21. In the present embodiment, the portable electronic device 100 further includes a control device (not shown). The control device receives the angle signal detected by the angle detector 40, and controls the working mode of the portable electronic device 100.

When an angle θ₁ is detected by the angle detector 40 and defined between the first display screen 11 and the second display screen 21 is arranged between 0 and 180 degrees, the control device controls the portable electronic device 100 to automatically change into a personal computer mode. In this working mode, one of the first display screen 11 or the second display screen 21 is an input terminal, such as keypad, and the other one is an output terminal, such as liquid crystal display.

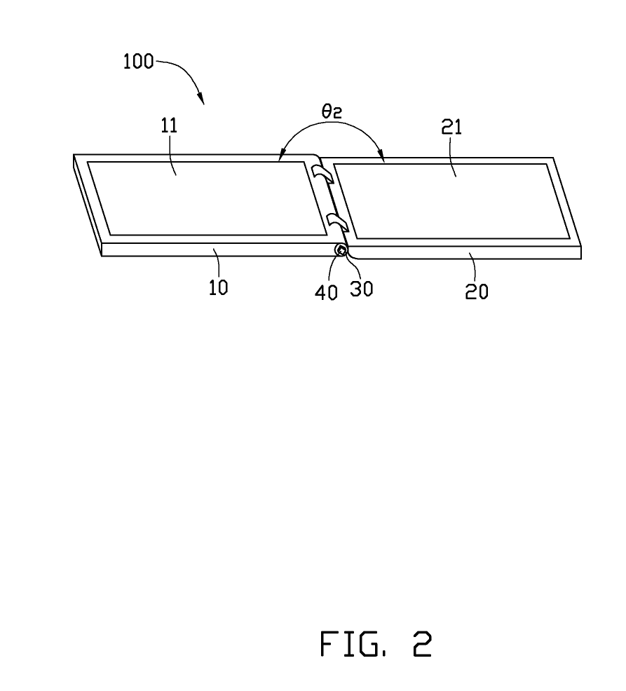

Referring to FIG. 2, when an included angle θ₂ is detected by the angle detector 40 and defined between the first display screen 11 and the second display screen 21 is 180 degrees, the control device controls the portable electronic device 100 to automatically to change into E-book mode. In this working mode, both of the first display screen 11 and the second display screen 21 can be an input terminal or output terminal. In other words, one of the first display screen 11 or the second display screen 21 is an input terminal, and the other one is an output terminal. In addition, one of the first display screen 11 or the second display screen 21 is an input terminal, and both of them can be an output terminal, therefore, the portable electronic device 100 sets to a full screen mode. Furthermore, it can use software to control the output information to achieve other added functions, such as locking, scroll up and down, automatic page turning, reading et al.

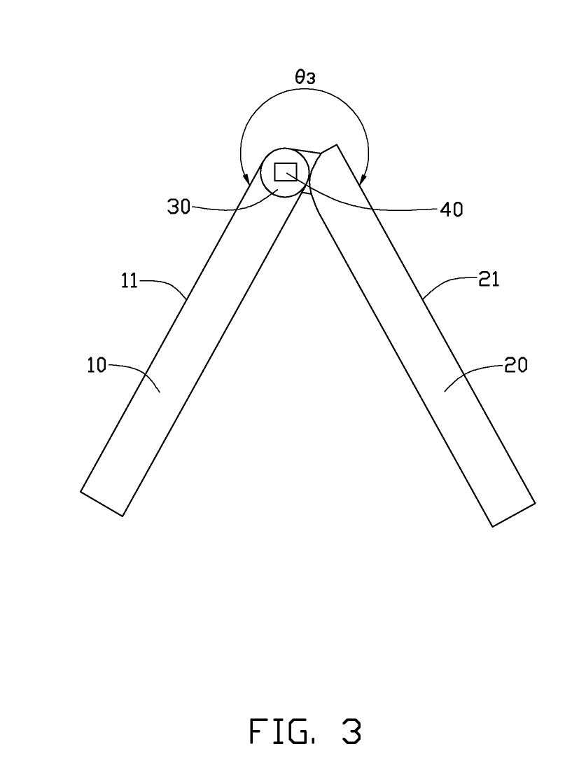

Referring to FIG. 3, when the included angle θ₃ is detected by the angle detector 40 and defined between the first display screen 11 and the second display screen 21 is arranged between 180 and 360 degrees, the control device controls the portable electronic device 100 to automatically switch to an electronic album mode. In this working mode, both of the first display screen 11 and the second display screen 21 can be an input terminal or an output terminal. When user inputs photos to the portable electronic device 100, it can use software to control the output information to achieve locking, scroll up and down, turn page automatically, play automatically et al.

It can be understood that when the included angle detected by the angle detector 40 and defined between the first display screen 11 and the second display screen 21 is zero, the portable electronic device 100 is shut down, and the control device controls the portable electronic device 100 to automatically switch to standby mode or off mode.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A portable electronic device comprising:
a first display device having a first display screen;
a second display device having a second display screen;
a pivot device configured for connecting the first display device and the second display screen; and
an angle detector detecting an angle defined by the first display screen and the second display screen;
wherein when the angle is 180 degree, the first display device and the second display device being positioned in the same horizontal plane, the portable electronic device being automatically switching to an E-book mode;
wherein when the angle is arranged between 0 and 180 degrees, the portable electronic device being automatically switching to a personal computer mode; and
wherein when the angle is arranged between 180 360 degrees, the portable electronic device being automatically switching to an electronic album mode.

2. The portable electronic device of claim 1, wherein the angle detector is arranged at the pivot device.

3. The portable electronic device of claim 1, wherein at least one of the first display screen and the second display screen is a display screen integrated with touch keypad.

4. A portable electronic device comprising:
a first display device having a first display screen;
a second display device having a second display screen;
a pivot device configured for connecting the first display device and the second display screen, an angle being defined by the first display screen and the second display screen can be changed; and
an angle detector detecting the different angles defined by the first display screen and the second display screen;
wherein the portable electronic device has at least two working modes corresponding to the different angles, respectively, the portable electronic device automatically switching to a corresponding working mode according the angle being detected by the angle detector.

5. The portable electronic device of claim 4, wherein the portable electronic device comprising a personal computer mode and an E-book mode, when the angle being 180 degree, the first display device and the second display device being positioned in the same horizontal plane, the portable electronic device being automatically switching to an E-book mode; when the angle being arranged between 0 and 180 degrees, the portable electronic device being automatically switching to a personal computer mode.

6. The portable electronic device of claim 5, wherein the portable electronic device further comprising an electronic album mode, when the angle being arranged between 180 and 360 degrees, the portable electronic device being automatically switching to the electronic album mode.

7. The portable electronic device of claim 4, wherein the angle detector is arranged at the pivot device.

8. The portable electronic device of claim 4, wherein at least one of the first display screen and the second display screen is a display screen integrated with touch keypad.
